(19) United States
(12) Patent Application Publication
(10) Pub. No.: US 2017/0277503 A1
(43) Pub. Date: Sep. 28, 2017

(54) MOVING DISPLAY IMAGES FROM ONE SCREEN TO ANOTHER SCREEN BY HAND GESTURING

(71) Applicant: Panasonic Automotive Systems Company of America, Division of Panasonic Corporation of North America, Peachtree City, GA (US)

(72) Inventors: SACHIKO KOBAYASHI, NOVI, MI (US); DAVID LYON, HUNTINGTON WOODS, MI (US); GARY L. BRADDOCK, GROSSE POINTE, MI (US); NARAYANI MITAL, ROYAL OAK, MI (US)

(21) Appl. No.: 15/459,373

(22) Filed: Mar. 15, 2017

Related U.S. Application Data
(60) Provisional application No. 62/311,434, filed on Mar. 22, 2016.

(51) Int. Cl. G06F 3/14; G06F 3/0488; G09G 5/14; G06F 3/01

(52) U.S. Cl. CPC G06F 3/1454; G06F 3/017; G06F 3/04883; G09G 5/14

(57) ABSTRACT

A display management arrangement for a motor vehicle includes a first display screen and a second display screen disposed on a dashboard of the motor vehicle. An electronic processor is disposed in the motor vehicle. The electronic processor is in communication with each of the first display screen and the second display screen. The electronic processor responds to a hand gesture by a user by transferring at least a portion of an image displayed on the first display screen to the second display screen.

### CROSS-REFERENCED TO RELATED APPLICATIONS

This application claims benefit of U.S. Provisional Application No. 62/311,434 filed on Mar. 22, 2016, which the disclosure of which is hereby incorporated by reference in its entirety for all purposes.

### FIELD OF THE INVENTION

The disclosure relates to graphical display management in a motor vehicle.

### BACKGROUND OF THE INVENTION

Although multiple display screens may be provided within a motor vehicle, it is not possible to move a display image from one display screen to another display screen within a motor vehicle.

SUMMARY

The present invention may enable gesture control (e.g., swiping) of information from one display to another. For example, map/navigation information may be swiped from the CenterStack to the cluster within the motor vehicle.

The invention may further enable swipe gesturing with visually appealing effects, such as a curtain effect, or other graphical feedback. Such visually appealing effects may not include distracting effects.

In one embodiment, the invention comprises a display management arrangement for a motor vehicle, including a first display screen and a second display screen disposed on a dashboard of the motor vehicle, on a head up display (HUD), or on any other display that can be part of the system such as Intelligent Rear view Monitor, passenger side monitor/HUD, etc. An electronic processor is disposed in the motor vehicle. The electronic processor is in communication with each of the first display screen and the second display screen. The electronic processor responds to a hand gesture by a user by transferring at least a portion of an image displayed on the first display screen to the second display screen.

In another embodiment, the invention comprises a display management method for a motor vehicle. The method includes providing a first display screen and a second display screen on a dashboard of the motor vehicle. A hand gesture by a user is responded to by ceasing to display first information on the first display screen, and initiating displaying of the first information on the second display screen.

In yet another embodiment, the invention comprises a display management arrangement for a motor vehicle, including a first display screen and a second display screen disposed on a dashboard of the motor vehicle. The first display screen is touch sensitive and/or the system may be sensitive to gestures, which may be three-dimensional, by use of a camera, proximity sensor (ITO), etc. An electronic processor is disposed in the motor vehicle, and is in communication with each of the first display screen and the second display screen. The electronic processor is configured to respond to a swipe of the user's finger on the first display screen by transferring at least some information displayed on the first display screen to the second display screen.

An advantage of the present invention is that it may provide a quick and appealing visual feedback to the swiping functions, such as the “curtain” effect on a slider, as gesture control is used to move information from one screen to another. The invention may provide simple and appealing, but not distracting, visual feedbacks, which help the driver see and understand where the information is moving to. Thus, another advantage of the present invention is improved information organization and personalization. The driver can customize the information shown on each screen to be in the form in which he wants to see the information. The interface can be optimized with selected gestures and visual feedback.

Yet another advantage is that the driver can move visual information to a location at which it is easily visible. The driver can move the information while taking his eyes off the road for a minimal length of time.

### BRIEF DESCRIPTION OF THE DRAWINGS

A better understanding of the present invention will be had upon reference to the following description in conjunction with the accompanying drawings.

FIG. 1 is a block diagram of one example embodiment of an automotive display management arrangement of the present invention.

FIG. 2 is a plan view of the two display screens of the automotive display management arrangement of FIG. 1 on a motor vehicle's dashboard.

FIG. 3 is a flow chart of one embodiment of a display management method of the present invention for a motor vehicle.

### DETAILED DESCRIPTION OF THE PREFERRED EMBODIMENTS

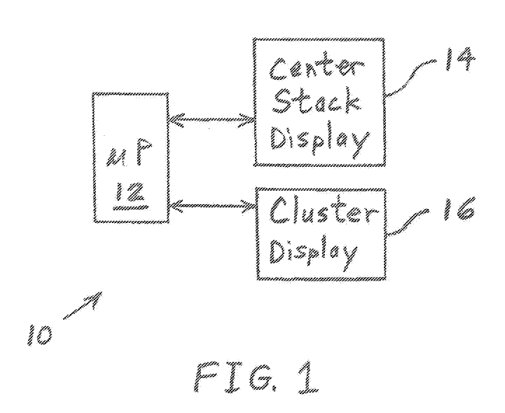

FIG. 1 illustrates one embodiment of an automotive display management arrangement 10 of the present invention. Double arrows indicate bi-directional communication between blocks. Arrangement 10 includes an electronic processor 12, a center stack display 14, and a cluster display 16. Each of center stack display 14 and cluster display 16 may have a touch-sensitive screen.

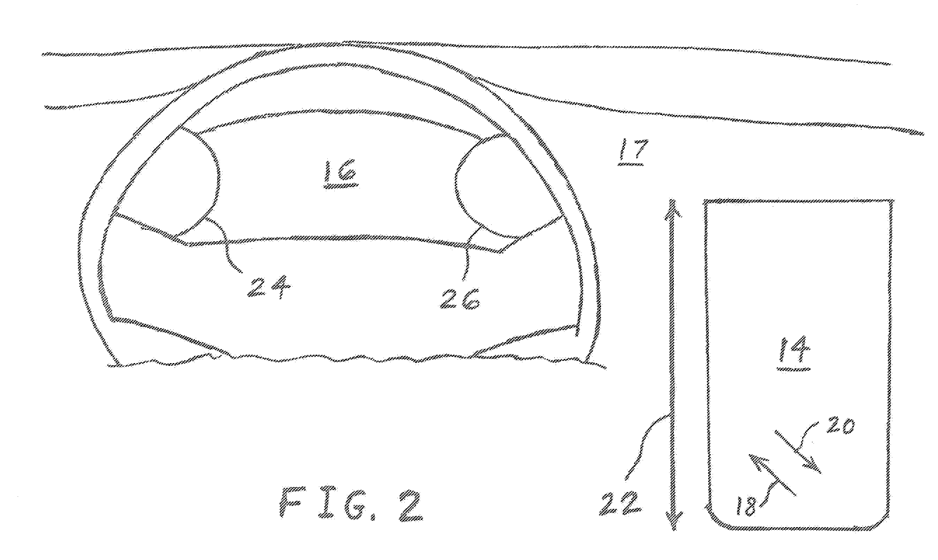

FIG. 2 illustrates a center stack display 14, and a cluster display 16 suitable for use in arrangement 10. Center stack display 14 and cluster display 16 are both disposed on a dashboard 17 of a motor vehicle. In one embodiment, a user may move information from center stack display 14 to cluster display 16 by swiping his finger across center stack display 14 in the general direction indicated by arrow 18. Conversely, the user may move information from cluster display 16 to center stack display 14 by swiping his finger across center stack display 14 in the general direction indicated by arrow 20, opposite to arrow 18.

In another embodiment, center stack display 14 includes a plurality of sections each including a different type of information. In response to a user's swipe (e.g., in direction 18), the section of center stack display 14 that has or received the longest portion of the user's swipe has its information transferred to cluster display 16. After the removal of one section of information, center stack display 14 may re-proportion the remaining sections over the entire available display area either automatically, or in response to a gesture, such as the user swiping his finger along the entire height 22 of center stack display 14. The highest priority (e.g., the largest portion of available display area) may be assigned to remaining sections that are most used (e.g., sections directed to audio and navigation). Sections that are used less frequently may include driver information and telephone projection information, and may be assigned lower priority (e.g., a. smaller portion of available display area). Highly prioritized sections may be provided with larger font size and touch areas. Lower prioritized sections may be provided with smaller font size and touch areas.

In one specific embodiment, cluster display 16 may be in the form of a 12.3-inch reconfigurable display with reconfigurable three-dimensional aluminum rings 24, 26. Center stack display 14 may be in the form of an 11.6-inch portrait touchscreen with capacitive knobs and reconfigurable touch pad switches. Both center stack display 14 and cluster display 16 may be driven by a same multimedia device. Other displays, such as a head up display (HUD), or any other display that can be part of the system, such as Intelligent Rear view Monitor, passenger side monitor/HUD, etc. may also be driven by the same “brain”, e.g., processor 12.

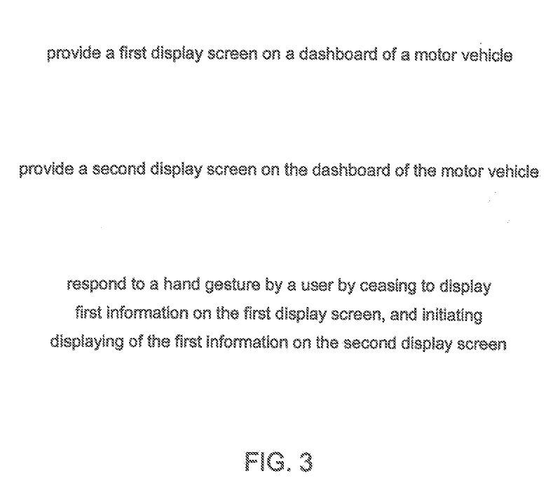

FIG. 3 illustrates one embodiment of a display management method 300 of the present invention for a motor vehicle. In a first step 302, a first display screen is provided on a dashboard of a motor vehicle. For example, center stack display 14 may be provided on dashboard 17.

Next, in step 304, a second display screen is provided on the dashboard of the motor vehicle. For example, cluster display 16 may be provided on dashboard 17.

In a final step 306, a hand gesture by a user is responded to by ceasing to display first information on the first display screen, and initiating displaying of the first information on the second display screen. For example, a user swiping his finger across center stack display 14 in direction 18 may cause information displayed on center stack display 14 to no longer be displayed on center stack display 14, and instead be displayed on cluster display 16.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A display management arrangement for a motor vehicle, the arrangement comprising;
a first display screen disposed on a dashboard of the motor vehicle;
a second display screen disposed on the dashboard of the motor vehicle; and
an electronic processor disposed in the motor vehicle, the electronic processor being in communication with each of the first display screen and the second display screen, the electronic processor being configured to respond to a hand gesture by a user by transferring at least a portion of an image displayed on the first display screen to the second display screen.

2. The display management arrangement of claim 1 wherein the first display screen is touch sensitive, the hand gesture comprising a swipe of the user's finger on the first display screen.

3. The display management arrangement of claim 2, wherein the swipe of the user's finger is generally in a direction toward the second display screen.

4. The display management arrangement of claim 1 wherein the hand gesture comprises a first hand gesture, the electronic processor being configured to respond to a second hand gesture by a user by transferring at least a portion of an image displayed on the second display screen to the first display screen.

5. The display management arrangement of claim 4 wherein the first display screen is touch sensitive, the first hand gesture comprising a swipe of the user's finger on the first display screen in a first direction toward the second display screen, the second hand gesture comprising a swipe of the user's finger on the first display screen in a second direction substantially opposite to the first direction.

6. The display management arrangement of claim wherein the first display screen comprises a center stack display, and the second display screen comprises a cluster display.

7. The display management arrangement of claim I wherein the electronic processor is configured to respond to a hand gesture by a user by:
transferring first information displayed on the first display screen to the second display screen; and
reconfiguring an image displayed on the first display screen to spread out the display of second information remaining after the first information has been transferred to the second display screen.

8. A display management method for a motor vehicle, the method comprising:
providing a first display screen on a dashboard of the motor vehicle;
providing a second display screen on the dashboard of the motor vehicle; and
responding to a hand gesture by a user by ceasing to display first information on the first display screen, and initiating displaying of the first information on the second display screen.

9. The display management method of claim 8 wherein;
the first display screen is touch sensitive, the hand gesture comprising a swipe of the user's finger on the first display screen;
a camera detects the hand gesture, the hand gesture comprising a three-dimensional hand gesture; and/or
a steering wheel switch detects the hand gesture, the hand gesture comprising an actuation of the steering wheel switch.

10. The display management method of claim 9 wherein the swipe of the user's finger is generally in a direction toward the second display screen.

11. The display management method of claim 8 wherein the hand gesture comprises first hand gesture, the method further comprising responding to a second hand gesture by ceasing to display second information on the second display screen, and initiating displaying of the second information on the first display screen.

12. The display management method of claim 11 wherein the first display screen is touch sensitive, the first hand gesture comprising a swipe of the user's finger on the first display screen in a first direction toward the second display screen, the second hand gesture comprising a swipe of the user's finger on the first display screen in a second direction substantially opposite to the first direction.

13. The display management method of claim 11 wherein the second information includes at least a portion of the first information.

14. The display management method of claim 8 wherein the first display screen comprises a center stack display, and the second display screen comprises a cluster display.

15. The display management method of claim 8 comprising the further step of reconfiguring an image displayed on the first display screen to spread out the display of second information remaining after the first information is no longer displayed on the first display screen.

16. A display management arrangement for a motor vehicle, the arrangement comprising:
a first display screen disposed on a dashboard of the motor vehicle, the first display screen being touch sensitive;
a second display screen disposed on the dashboard of the motor vehicle; and
an electronic processor disposed in the motor vehicle, the electronic processor being in communication with each of the first display screen and the second display screen, the electronic processor being configured to respond to a swipe of the user's finger on the first display screen by transferring at least some information displayed on the first display screen to the second display screen.

17. The display management arrangement of claim 16 wherein the swipe of the user's finger is generally in a direction toward the second display screen.

18. The display management arrangement of claim 16 wherein the swipe of the user's finger comprises a first swipe of the user's finger, the electronic processor being configured to respond to a second swipe of the user's finger on the first display screen by transferring at least some information displayed on the second display screen to the first display screen.

19. The display management arrangement of claim 18 wherein the first swipe of the user's finger on the first display screen is in a first direction, and the second swipe of the user's finger on the first display screen is in a second direction substantially opposite to the first direction.

20. The display management arrangement of claim 16 Wherein the first display screen comprises a center stack display, and the second display screen comprises a cluster display.
